(19) United States
(12) Patent Application Publication
(10) Pub. No.: US 2026/0251570 A1
(43) Pub. Date: Aug. 27, 2026

(54) LABORATORY MACHINE AND METHOD FOR PROCESSING A SAMPLE

(71) Applicant: HOMBRECHTIKON SYSTEMS ENGINEERING AG, Hombrechtikon (CH)

(72) Inventors: Konstantin LUTZE, Uerikon (CH); Harald QUINTEL, Steckborn (CH)

(21) Appl. No.: 19/544,865

(22) Filed: Feb. 19, 2026

(30) Foreign Application Priority Data
Feb. 26, 2025 (EP) 25160388.2

(51) Int. Cl. G01N 21/63

(52) U.S. Cl. CPC G01N 21/63

(57) ABSTRACT

A laboratory machine for processing a sample includes a treatment chamber to process the sample, a sample receiving element arranged in the treatment chamber to receive the sample, an illumination unit, the sample receiving element configured to be arranged on the illumination unit to irradiate the sample with a primary radiation, an analysis unit arranged in the treatment chamber to analyze the sample by receiving a secondary radiation originating from the sample and induced by the primary radiation, and the sample receiving element configured to be arranged at least partially above the illumination unit such that the sample receiving element is capable of being irradiated in a first region and in further regions different from the first region by the primary radiation generated by the illumination unit.

### CROSS-REFERENCE TO RELATED APPLICATION

This application claims priority to European Application No. 25160388.2, filed February 26, 2025, the contents of which are hereby incorporated herein by reference.

### TECHNICAL FIELD

The disclosure relates to a laboratory machine for processing a sample and to a method for processing a sample.

### BACKGROUND

When processing a plurality of samples, a plurality of processing steps must be carried out. For this purpose, laboratory machines are generally used since precise pipetting of reagents into and out of containers such as microtiter plates must be ensured.

Conventional laboratory machines generally comprise a treatment chamber into which the samples are introduced into microtiter plates (or other containers); a pipetting device for carrying out the processing steps; a movement device for moving the pipetting device in the treatment chamber and an electronic control device which controls and instructs the pipetting device and other parts of the laboratory machine for carrying out the processing steps.

The laboratory machines thus ensure an automated sample processing process with increased efficiency and improved throughput. An improved version of a laboratory machine is shown, for example, in EP 3894871 B1.

The laboratory machines often also have integrated optical detection devices for analyzing the samples.

### SUMMARY

Laboratory machines are particularly preferably used in biochemistry for processing biological samples, such as biomolecules (for example DNA or RNA), for instance for molecular biological and biochemical analyses, sequencing preparations, cell culture analyses or immunological tests (e.g. ELISA).

Laboratory machines therefore have a wide field of application, for example in clinical diagnostics, in pharmaceutical research (e.g. active ingredient screening), forensic analysis, food analysis and environmental analysis or for material research and surface research.

In particular in the case of biomolecules, luminescence spectroscopy is an important analysis method in which the emission light which arises on the basis of a photon absorption of the biomolecules is evaluated.

For this purpose, fluorescent chemical groups which then serve as markers for this biomolecule can be attached to large biomolecules by a fluorescent label.

Fluorescence is to be understood here as meaning the short-term, spontaneous emission of light which takes place during a transition of an electronically excited system back into a state of lower energy. Fluorescence is therefore a form of luminescence in which the excitation takes place by absorption of photons (photoluminescence). Formally, the fluorescence therefore represents the reversal of the adsorption of light in which a deactivation of excited electron states takes place by re-emission of the excitation energy as radiation.

In many processes, in particular the concentration of the fluid samples (that is to say of the relevant molecules in solution) plays a role for further processing, which can be determined simply in particular by fluorescence spectroscopy.

In the prior art, illumination units are used to illuminate or to irradiate regions or partial regions of a sample to be examined.

This takes place particularly frequently in microscopes and binoculars, as shown in DE102007029894A1 and DE102009028149A1.

As already mentioned above, an improved laboratory machine for processing a sample is already disclosed in EP3894871.

It has been determined that a disadvantage in the laboratory machines in the prior art is the illumination of the sample to be examined. In the prior art, this takes place from above, which makes the analysis of the sample more difficult. If, for instance, radiation is to be transmitted through the sample, in particular the entire sample, in order to analyze the latter, the analysis part of the laboratory machine must be arranged on the underside of the sample. However, such an arrangement is associated with a complicated construction, in particular if several samples are to be processed in the laboratory machine. Alternatively, the sample must be introduced into an analysis device, which constitutes an additional complex processing step. However, such constructions are more complex, more inflexible and do not permit efficient processing.

Therefore, the object of the present disclosure is to provide a device for the illumination of samples which eliminates the disadvantages known from the prior art, in particular to improve a laboratory machine for processing a sample in such a way that the analysis of samples takes place more simply and efficiently.

This object is met according to the disclosure by a laboratory machine for processing a sample and a method for processing a sample with a laboratory machine having the features dsiclsoed herein.

The disclosure further relates to particularly advantageous embodiments.

According to the disclosure, a laboratory machine for processing a sample with a treatment chamber for processing the sample, a sample receiving element arranged in the treatment chamber for receiving the sample and an illumination unit is proposed.

In this case, the sample receiving element can be arranged on the illumination unit for irradiating the sample, in particular a fluid sample, with a primary radiation. In addition, the laboratory machine comprises an analysis unit arranged in the treatment chamber for analyzing the sample. In this case, the analysis can be carried out by receiving a secondary radiation originating from the sample and induced by the primary radiation. According to the disclosure, the sample receiving element can be arranged at least partially above the illumination unit in such a way that the sample receiving element (or a sample/samples arranged therein) can be irradiated in a first region and in further regions different from the first region by the primary radiation which can be generated by the illumination unit. In this case, these regions can overlap or else be completely separated from one another and the regions can be irradiated simultaneously or successively. In particular, the sample receiving element can be arranged on the illumination unit. In this case, the illumination unit can emit different wavelengths or wavelength ranges as primary radiation.

The arrangement according to the disclosure has the advantage that specific regions of the sample receiving element and therefore also of the sample can be irradiated individually and independently in a targeted manner. That is to say either only a specific region of a single sample, only a specific plurality of samples or a single sample can be irradiated selectively. In particular, an irradiation from below can be carried out by the device according to the disclosure, with the result that the analysis of the sample can be carried out flexibly by the arrangement of the analysis unit at any accessible point.

Furthermore, the flexibility of the laboratory machine can be increased, since samples which differ, for instance, in terms of mass, volume or density can be processed individually without the construction of the laboratory machine in the interior having to be changed. In addition, the illumination of the sample from below, synonymous with the transmission of radiation through the entire sample, allows the analysis of the sample to be carried out by an analysis unit which is arranged and/or can be arranged laterally and/or above the sample. In particular in the case of the analysis of a plurality of samples in the laboratory machine, the construction is simplified by this device, because the movement of the analysis unit between the individual samples to be analyzed can thus take place more simply. Nevertheless, it can be ensured in this laboratory machine according to the disclosure that the sample is irradiated sufficiently to make all necessary details visible or detectable by the analysis unit.

The analysis can be used here in particular in cell analysis, for instance for tracking cells, markers, biomolecules and/or macromolecules. Furthermore, the analysis allows the observation and evaluation of the growth of cells, biomolecules and/or macromolecules.

In this case, the irradiation of different regions of the sample receiving element can be carried out by an illumination from different directions.

In the context of this disclosure, the term "sample" can be understood to mean in particular a fluid sample which comprises a liquid with substances such as biomolecules (inter alia DNA, RNA, nucleic acids, proteins, cells and cell constituents, monomers) or other chemical substances. In the context of the disclosure, a liquid can be a suitable solvent.

The laboratory machine according to the disclosure can also have a sample processing device for receiving and dispensing a fluid, which is arranged in the treatment chamber. In this case, the sample processing device can be configured in particular as a pipetting device for receiving and dispensing a fluid. In this case, the sample processing device can be designed for receiving a pipette tip, preferably for receiving the pipette tip in a fluid-tight manner. The sample can be transferred into the sample receiving element by pipetting by a pipetting device for receiving and dispensing a fluid. The sample receiving element with the sample contained therein can then be arranged in the laboratory machine above the illumination unit in such a way that the sample can be illuminated or irradiated from below. In this case, the sample receiving element can be in particular a pipette tip. Likewise, the sample receiving element can be configured for receiving a pipette tip. Thus, fluids can be pipetted in various processing steps. However, in the context of this application, the analysis by the analysis unit is also a processing step.

In this case, the irradiation can be carried out from directly below the sample and from laterally below the sample or can also be carried out laterally from the sample. This has the advantage that the relative arrangement of the analysis unit and of the illumination unit with respect to one another and the arrangement of the analysis unit and of the illumination unit around the sample receiving element can be adapted in such a way that they can be adapted to the respective properties of the sample to be analyzed, of the arrangement of the sample receiving element and/or of the selected analysis method. In this way, the flexibility of the laboratory machine according to the disclosure is increased and a faster mode of operation is made possible.

In a preferred exemplary embodiment of the laboratory machine, the illumination unit comprises an illumination element. In this case, the illumination element can be moved in the illumination unit in such a way that the sample receiving element can be irradiated in the first region and in the further regions different from the first region by the primary radiation which can be generated by the illumination unit.

This has the advantage that the sample can be irradiated in a targeted manner. At the same time, the sample can thus be irradiated from different directions, as a result of which the quality of the data collected can be increased or comparative measurements can be carried out. In addition, it is possible in this way to irradiate individual sections in a very targeted manner, with the result that less energy is consumed than by the illumination units known from the prior art. Several samples can also be irradiated in this way if a plurality of them is arranged in the laboratory machine. Furthermore, only one illumination element is necessary in this exemplary embodiment, whereas several illumination elements are used in the prior art in order to illuminate the entire size of the sample receiving element. This multiple provision is cost-intensive and maintenance-intensive. However, since the present illumination element can be moved in the illumination unit, only one illumination element is necessary. Consequently, material costs and maintenance costs can thus be saved compared with the prior art. In addition, the arrangement of the illumination unit under the sample permits a space-saving arrangement in the laboratory machine, with the result that a more compact construction is made possible.

In a preferred exemplary embodiment of the laboratory machine, the illumination unit comprises an illumination element, wherein the illumination element comprises a plurality of light sources which can be actuated in such a way that the sample receiving element can be irradiated in the first region and in the further regions different from the first region by the primary radiation which can be generated by the illumination unit.

This has the advantage that the sample or the samples can be irradiated in a targeted manner. It is likewise possible to irradiate the sample or the samples in a targeted manner, individually and in sections. In addition to the increased flexibility of the laboratory machine, the error rate in measurements and observations can hereby be reduced. At the same time, the sample can thus be irradiated from different directions, as a result of which the quality of the data collected can be increased.

The treatment chamber can comprise in particular a storage container for samples. This allows, on the one hand, faster processing of samples since these samples and the receiving containers provided for this purpose are already inside the treatment chamber and, on the other hand, ensures safer storage of potentially dangerous and/or valuable samples. Furthermore, it increases the purity of the treatment chamber since the latter has to be opened less frequently in order to provide new samples.

In a preferred exemplary embodiment of the laboratory machine, the illumination element comprises a deuterium lamp, a tungsten lamp, a halogen lamp and/or an LED. This has the advantage that different radiations can be emitted by the illumination element. Consequently, different wavelengths can be examined during the analysis of the sample in order to detect information such as, for example, any changes in the sample. Preferably, these wavelengths are the spectrum of the visible light, the UV radiation or else X-ray radiation. Particularly preferably, the illumination unit is a luminous plate (or a plurality of luminous plates), in particular an LED luminous plate and/or a luminous plate with actuatable pixels.

In this case, the radiation of the illumination element can reach the sample receiving element in different ways, for instance as direct radiation, by a lens optical unit, by a light guide, via fibers, for example glass fibers, or a combination thereof.

In this case, the illumination element can be in particular oscillating and/or triggered or pulsed. This offers the advantage that the quality of the optical analysis can be improved since the image sharpness can be increased in this way, for instance for HDR recordings. Changes can thus be shown better. This is particularly advantageous when the images obtained are intended to be combined in order to improve the image quality.

In order to improve the analysis quality, all methods and apparatuses known to a person skilled in the art are also conceivable, such as, for instance, filters and diffusers for influencing the radiation.

In a preferred exemplary embodiment of the laboratory machine, the analysis unit comprises a plurality of detectors for receiving the secondary radiation. This has the advantage that the data received by each detector can be evaluated together in order to compensate for any errors or inaccuracies in the sensors. In particular, the data of the individual sensors can be averaged over an average value in order to increase the load-bearing capacity of the data. Since more load-bearing data are synonymous with a qualitatively higher result, the efficiency of the laboratory machine can thus be increased.

Since the plurality of samples can also be irradiated by the illumination unit, the plurality of samples can also be analyzed simultaneously by the plurality of detectors. This results in advantages for the efficiency of the laboratory machine, since several samples can thus be processed in the same time period.

Due to the flexible adjustability of the region to be illuminated, a selective analysis is additionally made possible, since the samples can be irradiated and analyzed selectively independently of the arrangement in the sample receiving element.

In a preferred exemplary embodiment of the laboratory machine, the analysis unit comprises a plurality of types of sensor for detecting signals or the secondary radiation. This means that, in particular, the secondary radiation can be recorded by the sensors, but other information, such as, for example, temperature changes, can also be recorded by the sensors. This has the advantage that several different parameters are in each case detected by different sensors.

In a preferred exemplary embodiment of the laboratory machine, the analysis unit comprises a photometer, in particular a spectrometer, in particular a fluorometer. It goes without saying here that the analysis unit can also comprise a combination of several or all of these detectors.

In a preferred exemplary embodiment of the laboratory machine for processing a sample, the laboratory machine comprises a movement device which is arranged so as to be movable in at least one first spatial direction of the treatment chamber, wherein the analysis unit can be moved to the sample by the movement device. The movable analysis unit has the advantage that the sample does not have to be moved for analysis. This is advantageous precisely when processes in an aqueous solution are investigated. Since the transport of the sample in an aqueous solution can lead to the investigated targets, such as, for instance, cells or macromolecules, being moved by external influences, the analysis results can be falsified by the latter. This risk is minimized by the movement of the analysis unit toward the sample.

In a preferred exemplary embodiment of the laboratory machine, the movement device can be moved in a second spatial direction, which is orthogonal to the first spatial direction, of the treatment chamber and in a third spatial direction, which is orthogonal to the first spatial direction and the second spatial direction of the treatment chamber.

As a result, the analysis unit can be adapted even more exactly and individually to the respective requirements of the sample, such as, for instance, the illumination direction or the physical form of the sample receiving element. This leads to more load-bearing data and more efficient and thus faster processing of the individual samples, due to more easily adjustable parameters, such as, for instance, distance and illumination direction.

In a preferred exemplary embodiment, the laboratory machine comprises an electronic control device for controlling the illumination element. In this case, the control device is signal-connected to the movement device and the analysis unit in such a way that the primary radiation emitted by the illumination element impinges on the analysis unit as secondary radiation. This has the advantage that the outgoing primary radiation can be directed onto the sample or the sample receiving element exactly and individually, without generating superfluous scattered light. It can thus be ensured, for example, that the radiation takes the path of the least scattering, for instance by a container being irradiated in such a way that the radiation penetrates directly into the container merely through the base and does not move through the walls of the container which are fitted vertically on this base and is strongly scattered in the process.

The signal connection can be carried out in particular by a cable, but also wirelessly, for instance via Bluetooth or radio.

In a preferred exemplary embodiment of the laboratory machine, the analysis unit comprises an infrared photometer for optical temperature measurement and/or a camera for analyzing the sample. In this case, the camera can in particular perceive and record the wavelengths of the visible light, UV light and X-ray radiation, but also other radiation. In this way, on the one hand, different wavelengths can be collected with regard to information about the sample and the chemical and/or biological processes in the interior thereof. On the other hand, these processes can be recorded in order to re-evaluate them if necessary. Precisely with regard to the continuously improving evaluation programs, it is advantageous if the processes can be analyzed repeatedly without re-building up and running through the entire process in the laboratory.

In a preferred exemplary embodiment of a laboratory machine, the illumination unit can be attached removably to an inner side and/or an outer side of the treatment chamber. In this case, the treatment chamber is formed by a transparent, i.e. translucent, material. Here, the illumination unit preferably extends over the entire outer side and/or inner side of the treatment chamber. This has the advantage that the illumination direction of the sample or of the sample receiving element can be adapted individually to the sample to be examined. This increases the flexibility and makes it possible to increase the quality of the data collected. In particular, the arrangement of the illumination unit over the entire outer side and/or inner side increases the flexibility since it allows the sample not only to be irradiated individually from all directions, but this is also possible simultaneously with a plurality of light sources of the illumination unit. In addition, it is thus possible to inhibit disturbing light from outside the treatment chamber, with the result that the light in the interior of the treatment chamber and therefore the illumination of the sample can be better controlled. A further advantage here is that less intense light has to be used for the illumination as there are fewer external influences to contend with.

It is likewise conceivable that the illumination unit is arranged freely in the treatment chamber. This is advantageous particularly when only small sample receiving elements are used. Here, the use of illumination units which do not cover large areas and thus save material is sufficient. Furthermore, the free arrangement in the treatment chamber can be advantageous when the treatment chamber, for instance caused by external influences, is very small or narrow and therefore only a few possible spaces are available for the arrangement of the illumination unit. An arrangement in a space outside the treatment chamber is likewise conceivable.

Furthermore, it is conceivable for the illumination unit to be arranged movably, analogously to the sample container, in the treatment chamber. In this case, the movable illumination unit is signal-connected to the movable sample container and/or the control device in such a way that the illumination unit can follow the sample container and the sample container is thus irradiated optimally. In this way, illumination elements and therefore material can be saved without the quality of the data collected being reduced.

In this case, the movement of the illumination unit can take place by a gripper, preferably an automated gripper.

In this case, the illumination unit can be configured in particular with an energy store, for example a rechargeable battery, with the result that the illumination unit can be arranged at different positions in the treatment chamber. In order to charge the energy store, it is conceivable for the treatment chamber to have at least one docking point at which the illumination unit and/or the energy store can be docked and/or charged and/or exchanged.

It is likewise disclosed that the illumination unit can be arranged outside the treatment chamber by the gripper. For this purpose, the docking points can likewise be arranged outside the treatment chamber. It is also furthermore possible to provide docking points which permit a signal connection between the illumination element and the laboratory machine. In this case, this signal connection can be present in addition to the charging function of the docking point or else without the charging function.

In a preferred exemplary embodiment of the laboratory machine, the illumination unit forms a wall surrounding the treatment chamber.

In a preferred exemplary embodiment of a laboratory machine according to the disclosure, the laboratory machine has a base element on which the sample receiving element can be arranged. In this case, the base element is formed completely by the illumination unit, wherein the illumination unit comprises a plurality of light sources which can be actuated in such a way that the sample receiving element can be irradiated in the first region and in the further regions different from the first region by the primary radiation which can be generated by the illumination unit.

This has the advantage that the sample or the sample receiving element can be irradiated in a targeted manner and the laboratory machine can operate more efficiently.

In addition, the irradiation of the sample or of the sample receiving element from below is advantageous since, in this way, the primary radiation migrates through the sample and the emitted secondary radiation falls directly on the analysis unit, particularly when the sample receiving elements are open at the upper end, that is to say the end remote from the base element, without having to pass through a further wall of the sample receiving element.

In particular, the base element can be the luminous plate. In this case, the base plate can have the following dimensions (length X width X height): 120-130 mm, 80-90 mm, 10-12 mm, preferably 125-130 mm, 83-88 mm, 12-17 mm, particularly preferably 127.076 mm, 85.48 mm, 14.35 mm.

In a preferred exemplary embodiment, the illumination unit can be adapted to the form of the sample receiving element, in particular to the external form, in order thus to permit irradiation of the sample receiving element as accurately as possible.

In a preferred exemplary embodiment, the laboratory machine has a heat source, in particular a heat source which can be arranged on and/or in the illumination element, such that a combination of light source and heat source can be formed. This is referred to below as a light element and heating element. The light element and heating element can have a separate light source and a separate heat source and/or a combined light-heat source.

It is conceivable that the heat source can likewise be actuated in such a way that the sample receiving element can be heated in the first region and in the further regions different from the first region.

In this case, the targeted heating can be carried out by means analogously to the targeted irradiation, that is to say for instance by a plurality of individually actuatable heat sources and/or by movable heat sources and/or individually actuatable heating elements and/or movable heating elements which together form the heat source.

In this case, the targeted heating offers the advantage that heat-dependent analyses and methods, such as for instance a PCR or other isothermal amplifications, can be carried out.

In order to increase the accuracy of such analyses and methods, it is conceivable for the heating element and/or the heat sources to have a temperature measuring element, for instance a thermometer. In this case, this temperature measuring element can be signal-connected and controllable, in particular movement-controlled, to the laboratory machine.

In addition, a method according to the disclosure for processing a sample with a laboratory machine is proposed, which method comprises the following steps. Providing a laboratory machine, introducing the sample into the treatment chamber, irradiating the sample with the illumination unit and analyzing the sample with the analysis unit. Receiving the analysis unit by the movement device, moving the analysis unit by the movement device through the treatment chamber to the sample and analyzing the sample by the analysis unit.

This has the advantage that the laboratory machine can operate more quickly and efficiently. Not only because the sample or samples and the analysis unit can be positioned precisely with respect to one another so quickly and efficiently, but also because the sample does not have to be moved manually by an employee. This reduces, on the one hand, the risk of spillage and, on the other hand, the quality of the sample and therefore of the data collected is thus not reduced by possible contamination by the employee. All together therefore leads to a safer, faster and more efficient workflow.

In an exemplary embodiment of the method according to the disclosure, the region of the sample receiving element irradiated by the primary radiation is determined by the position of the analysis unit. This takes place by virtue of the fact that the control device is signal-connected to the analysis unit and to the sample receiving element and can thus determine the relative position of the two with respect to one another. Furthermore, the control device is also signal-connected to the illumination unit, with the result that the control device can control the illumination unit.

### BRIEF DESCRIPTION OF THE DRAWINGS

It goes without saying that the exemplary embodiments mentioned here have no limiting character and the various features of the exemplary embodiments and the exemplary embodiments themselves can be combined with one another.

In the following, the disclosure is explained in more detail on the basis of exemplary embodiments with reference to the drawings. The drawings show:

FIG. 1 is a schematic illustration of a microscope known from the prior art with an illumination unit;

FIG. 2 is a schematic illustration of a laboratory machine known from the prior art;

FIG. 3 is a schematic illustration of a laboratory machine according to the disclosure with an illumination element;

FIG. 4 is a schematic illustration of a movable illumination unit;

FIG. 5 is a schematic illustration of an illumination unit with a plurality of light sources;

FIG. 6 is a schematic illustration of the spatial directions X, Y and Z;

FIG. 7 is a schematic illustration of a laboratory machine with an illumination unit covering the outer side of the treatment chamber;

FIG. 8 is a schematic illustration of a laboratory machine with a base element.

### DETAILED DESCRIPTION

In FIG. 1, a microscope for examining a sample or an object 20′ is illustrated schematically in a cross-sectional view and denoted overall by 700′. The microscope has a microscope body 4′ on which a microscope stage 30′ is arranged. The sample 20′ is positioned on the microscope stage 30′. An objective 10′ is provided on an objective holder 6′. An incident light illumination device 5′, which is not explained in more detail below, is provided, inter alia, for the illumination of the sample 20′. Furthermore, the microscope 700′ is equipped with the configuration 400′ of the illumination device.

The illumination light reflected by the sample 20′ reaches the eyepiece 9′ in the observation beam path via a tube 8′.

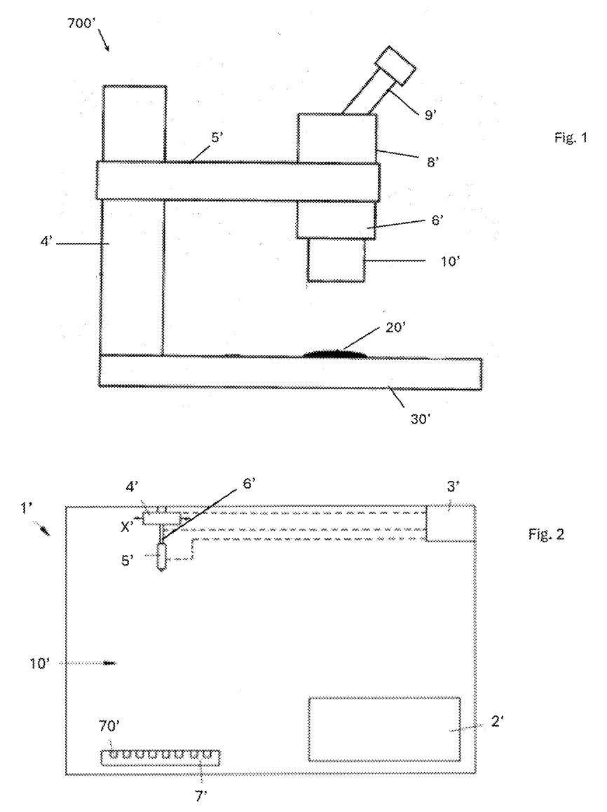

FIG. 2 shows a schematic illustration of a laboratory machine 1 known from the prior art.

The laboratory machine 1′ for processing a fluid sample 70′ comprises a treatment chamber 10′ for receiving the fluid sample 70′ and a sample processing device 6′ arranged in the treatment chamber 10′ for carrying out at least one processing step on the sample 70′. In addition, a storage container 2′ for samples 70′ is arranged in the treatment chamber 10′.

FIG. 2 furthermore shows a sample receiving element 7′ arranged in the treatment chamber 10′ for receiving the sample 70′, an illumination unit 11′, wherein the sample receiving element 7′ can be arranged on the illumination unit 11′ for irradiating the sample 70′ with a primary radiation.

In addition, a movement device 4′ is arranged in the treatment chamber 10′. The movement device 4′ can be moved at least in a first spatial direction x′ of the treatment chamber 10′. In this case, the movement device 4′ is connected to the sample processing device 6′ (i.e., the sample processing device 6' is incorporated into the movement device 4') in such a way that the sample processing device 6 can be moved through the treatment chamber 10′ in the first spatial direction x′ by the movement device 4′.

In addition, the laboratory machine 1′ comprises an electronic control device 3′ which is signal-connected to the sample processing device 6′, the movement device 4′ and the analysis unit 5′. The signal connection is indicated here via the dashed lines.

In the operating state, the control device 3′ can therefore transmit control signals for carrying out various processing steps to the sample processing device 6′, the movement device 4′ and the analysis unit 5′. Of course, the control device 3′ can also receive signals from the sample processing device 6′, the movement device 4′ and the analysis unit 5′.

In the case of the sample processing device 6′ and/or the movement device 4′, the signal connection takes place via a cable connection to the control unit 3′. In the case of the analysis unit 5′, the signal connection is wireless. The data/signal transmission therefore takes place via a free space (air or vacuum) as transmission medium. Electromagnetic radiation such as Bluetooth or WLAN is used for the transmission.

The analysis unit 5′ is controlled by the control device 3′, with the result that analyses can be carried out on a sample 70′, which analyses are carried out in a sample receiving element 7′ arranged in the treatment chamber 10′. In the features described above and the sample processing, the laboratory machine shown in FIG. 2 corresponds to the laboratory machine according to the disclosure, for which reason this basic function of the latter is not explained again below.

In contrast to the present disclosure, in the case of the laboratory machine from the prior art, no targeted, individual illumination of the sample or samples 70′ takes place from below or laterally from below. The flexible arrangement of the analysis unit 5 according to the laboratory machine according to the disclosure and the advantages resulting therefrom are likewise not shown here.

FIG. 3 shows a schematic illustration of a laboratory machine according to the disclosure with an illumination unit 11, wherein the illumination unit 11 is attached removably to an inner side of the treatment chamber 10.

The laboratory machine shown in FIG. 3 substantially corresponds to the laboratory machine shown in FIG. 2. Therefore, the reference signs there have been replaced only by reference signs without an inverted comma.

Furthermore, the laboratory machine according to FIG. 3 additionally has an analysis unit 5 arranged in the treatment chamber 10 for analyzing the sample 70 by receiving a secondary radiation originating from the sample 70 and induced by the primary radiation, wherein the sample receiving element 7 is arranged at least partially above the illumination unit 11 in such a way that the sample receiving element 7 can be irradiated in a first region A and in further regions B different from the first region A by the primary radiation which can be generated by the illumination unit 11.

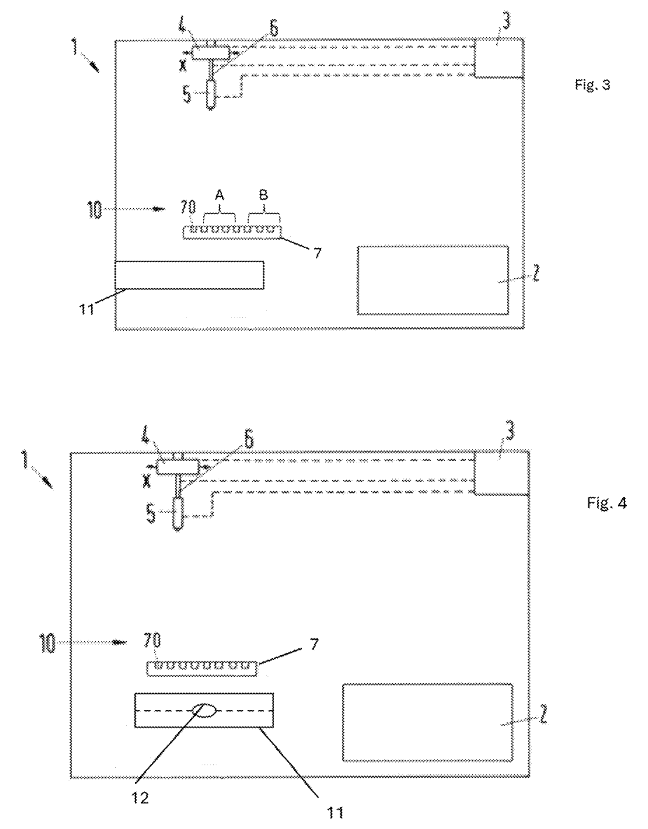

FIG. 4 shows a schematic illustration of a movable illumination unit 11 in a laboratory machine.

The illumination unit 11 of the laboratory machine in this case comprises an illumination element 12. The illumination element 12 can be moved in the illumination unit 11 in such a way that the sample receiving element 7 can be irradiated in the first region and in the further regions different from the first region by the primary radiation which can be generated by the illumination unit 11. In this case, the movement of the illumination unit 11 is illustrated schematically by a dashed line.

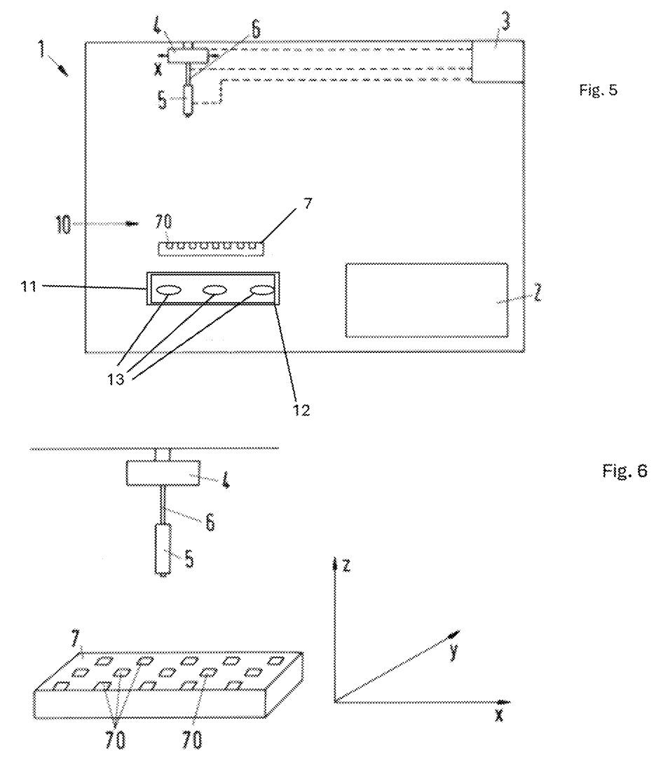

FIG. 5 shows a schematic illustration of an illumination unit 11 with a plurality of light sources 13, in that the illumination unit 11 comprises an illumination element 12 and the illumination element 12 comprises a plurality of light sources 13 which can be actuated in such a way that the sample receiving element 12 can be irradiated in the first region and in the further regions different from the first region by the primary radiation which can be generated by the illumination unit 12 .

In the laboratory machine shown in FIG. 5, the illumination element 12 can be a deuterium lamp, a tungsten lamp, a halogen lamp and/or an LED.

Furthermore, the analysis unit 5 has a plurality of detectors (not shown) for receiving the secondary radiation.

In this case, the analysis unit 5 of the laboratory machine shown here has a plurality of types of sensor/detectors for detecting signals or for detecting the secondary radiation.

FIG. 6 shows a schematic detail of a laboratory machine according to the disclosure, wherein the movement device 4 can be moved in a second spatial direction y, which is orthogonal to the first spatial direction, of the treatment chamber 10 and in a third spatial direction z, which is orthogonal to the first spatial direction x and the second spatial direction y, of the treatment chamber 10 .

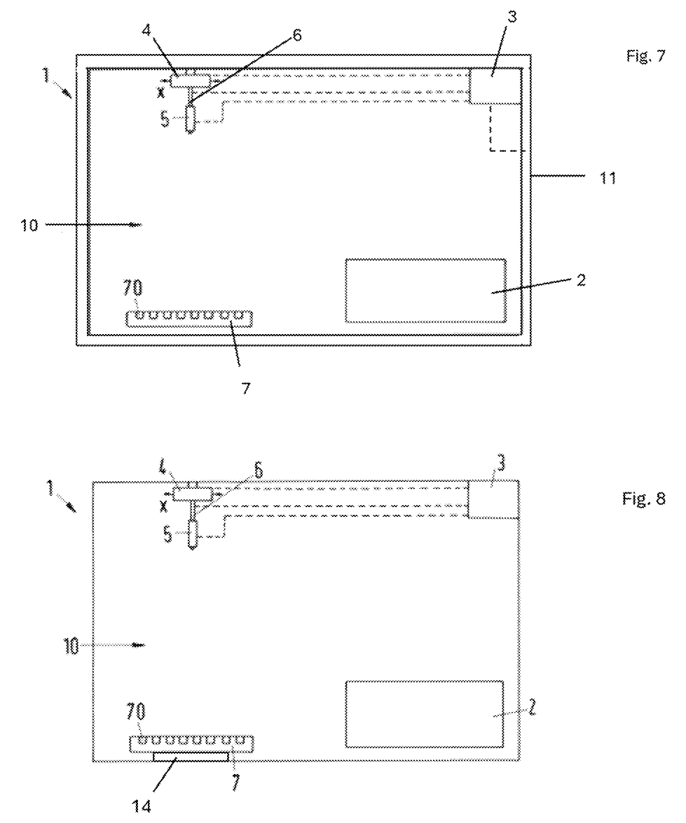

FIG. 7 shows a laboratory machine 1 with a wall surrounding the outer side of the treatment chamber 10, wherein the illumination unit 11 forms the wall surrounding the treatment chamber 10. Furthermore, the laboratory machine 1 shown comprises an electronic control device 3 for controlling the illumination element 12, wherein the control device 3 is signal-connected to the movement device 4 and the analysis unit 5 in such a way that the primary radiation emitted by the illumination element 12 impinges on the analysis unit 5 as secondary radiation.

FIG. 7 shows a laboratory machine 1, wherein the laboratory machine has a base element 14 on which the sample receiving element 7 is arranged. In this case, the base element 14 is formed completely by the illumination unit 11, wherein the illumination unit 11 comprises a plurality of light sources (not illustrated) which can be actuated in such a way that the sample receiving element 7 can be irradiated in the first region and in the further regions different from the first region by the primary radiation which can be generated by the illumination unit 11 .

As a result of the features explained above, the present disclosure therefore makes it possible for the first time to provide and use a laboratory machine which has an illumination unit which can be actuated in a targeted manner in such a way that it can irradiate a sample receiving element or the sample contained therein in a targeted manner and in sections.

As a result, the quality of the sample examination can be increased because the illumination takes place where it is necessary and can at the same time be controlled in such a way that less scattered light or even an overexposure is generated.

The joint control of the analysis unit, of the illumination unit and of the movement unit by the control device can also ensure that the relative arrangement of the individual components with respect to one another takes place optimally, with the result that the best possible illumination result is achieved.

A faster and better and therefore qualitatively higher-quality workflow is thus made possible.

The disclosure is not restricted to the disclosed embodiments. Other variations of the disclosed embodiments can be understood and brought about by persons skilled in the art when practicing a claimed disclosure from a study of the drawings, of the disclosure and of the dependent claims. In the claims, the word “comprising” does not exclude any other elements or steps, and the indefinite article “a” or “an” does not exclude a plurality. The mere fact that specific measures are repeated in dependent claims which differ from one another does not mean that a combination of these measures cannot be used advantageously. Any reference signs in the claims should not be interpreted as restricting the scope.

What is claimed:

1. A laboratory machine for processing a sample, comprising:
a treatment chamber configured to process the sample;
a sample receiving element arranged in the treatment chamber to receive the sample;
an illumination unit, the sample receiving element configured to be arranged on the illumination unit to irradiate the sample with a primary radiation;
an analysis unit arranged in the treatment chamber to analyze the sample by receiving a secondary radiation originating from the sample and induced by the primary radiation; and
the sample receiving element configured to be arranged at least partially above the illumination unit such that the sample receiving element is capable of being irradiated in a first region and in further regions different from the first region by the primary radiation generated by the illumination unit.

2. The laboratory machine according to claim 1, wherein the illumination unit comprises an illumination element and the illumination element is configured to be moved in the illumination unit such that the sample receiving element is capable of being irradiated in the first region and in the further regions different from the first region by the primary radiation generated by the illumination unit.

3. The laboratory machine according to claim 1, wherein the illumination unit comprises an illumination element and the illumination element comprises a plurality of light sources controllable such that the sample receiving element is capable of being irradiated in the first region and in the further regions different from the first region by the primary radiation generated by the illumination unit.

4. The laboratory machine according to claim 1, wherein the illumination element is a deuterium lamp, a tungsten lamp, a halogen lamp or an LED.

5. The laboratory machine according to claim 1, wherein the analysis unit comprises a plurality of detectors to receive the secondary radiation.

6. The laboratory machine according to claim 1, wherein the analysis unit is a photometer.

7. The laboratory machine according to claim 1, comprising a movement device which is arranged so as to be movable in at least one first spatial direction of the treatment chamber , wherein the analysis unit can be received by the movement device and can be moved to the sample by the movement device .

8. The laboratory machine according to claim 1, wherein the movement device is configured to be moved in a second spatial direction, orthogonal to the first spatial direction, of the treatment chamber and in a third spatial direction, orthogonal to the first spatial direction and the second spatial direction , of the treatment chamber .

9. The laboratory machine according to claim 8, comprising an electronic control device configured to control the illumination element, wherein the control device is signal-connected to the movement device and the analysis unit in such a way that the primary radiation emitted by the illumination element impinges on the analysis unit as secondary radiation.

10. The laboratory machine according to claim 1, wherein the analysis unit comprises an infrared photometer for optical temperature measurement or a camera for analyzing the sample .

11. The laboratory machine according to claim 1, wherein the illumination unit is configured to be removably attached to an inner side or an outer side of the treatment chamber.

12. The laboratory machine according to claim 1, wherein the illumination unit extends over an entire outer side or inner side of the treatment chamber .

13. The laboratory machine according to claim 1, wherein the illumination unit forms a wall surrounding the treatment chamber.

14. The laboratory machine according to claim 1, further comprising a base element, the sample receiving element configured to be arranged on the base element, the base element formed completely by the illumination unit and the illumination unit comprises a plurality of light sources configured to be actuated such that the sample receiving element is capable of being irradiated in the first region and in the further regions different from the first region by the primary radiation generated by the illumination unit.

15. A method for processing a sample using a laboratory machine, the method comprising:
providing a laboratory machine according to claim 1;
introducing the sample into the treatment chamber ;
irradiating the sample by the illumination unit ;
analyzing the sample by the analysis unit .

16. The method according to claim 15, wherein a position of the analysis unit determines whether the first region or the further regions of the sample receiving element are irradiated by the primary radiation.

17. The laboratory machine according to claim 1, wherein the analysis unit is a spectrometer.

18. The laboratory machine according to claim 1, wherein the analysis unit is a fluorometer.
